(19) United States
(12) Patent Application Publication
(10) Pub. No.: US 2026/0052043 A1
(43) Pub. Date: Feb. 19, 2026

(54) JOINT CHANNEL ESTIMATION AND PRECODER PREDICTION FOR TDD CELLULAR COMMUNICATION

(71) Applicant: Samsung Electronics Co., Ltd., Suwon-si (KR)

(72) Inventors: Murat Bayraktar, Morrisville, NC (US); Yan Xin, Princeton, NJ (US)

(21) Appl. No.: 19/193,825

(22) Filed: Apr. 29, 2025

Related U.S. Application Data
(60) Provisional application No. 63/684,181, filed on Aug. 16, 2024.

(51) Int. Cl. H04L 25/02; G06N 3/0442; H04B 7/06; H04L 41/16

(52) U.S. Cl. CPC H04L 25/0224; G06N 3/0442; H04B 7/0639; H04L 41/16

(57) ABSTRACT

A base station (BS) includes a processor configured to identify a joint sounding reference signal (SRS) channel estimation (CE) and precoding matrix indicator (PMI)-based precoder prediction model trained with a training data set. The BS also includes a transceiver operatively coupled to the processor, the transceiver configured to receive at least one subband (SB)-level PMI-based precoder sequence and at least one subcarrier-level noisy SRS-based sequence. The processor is further configured to provide, to the trained joint SRS CE and PMI-based precoder prediction model, the at least one SB-level PMI-based precoder sequence and the at least one subcarrier-level noisy SRS-based sequence, and receive, from the trained joint SRS CE and PMI-based precoder prediction model, a predicted precoder generated by the trained joint SRS CE and PMI-based precoder prediction model based on the at least one SB-level PMI-based precoder sequence and the at least one subcarrier-level noisy SRS-based sequence.

### CROSS-REFERENCE TO RELATED APPLICATION(S) AND CLAIM OF PRIORITY

This application claims priority under 35 U.S.C. § 119 (e) to U.S. Provisional Patent Application No. 63/684,181 filed on Aug. 16, 2024. The above-identified provisional patent application is hereby incorporated by reference in its entirety.

### TECHNICAL FIELD

This disclosure relates generally to wireless networks. More specifically, this disclosure relates to joint channel estimation (CE) and precoder prediction for time division duplex (TDD) multiple-input multiple-output (MIMO) cellular communication.

### BACKGROUND

Wireless communication systems use channel state information (CSI) to establish a reliable communication link between a transmitter and receiver. Modern wireless communications receive regular CSI updates because the physical channel rapidly changes. For cellular systems, CSI can be obtained via sounding reference signal (SRS) or CSI feedback mechanisms. Signal processing methods have been developed for CE and CSI feedback. However, existing CE and CSI feedback methods incur an overhead on the communication system, reducing the resources available for data transmission.

### SUMMARY

This disclosure provides joint CE and precoder prediction for TDD cellular communication.

In one embodiment, a base station (BS) is provided. The BS includes a processor configured to identify a joint sounding reference signal (SRS) channel estimation (CE) and precoding matrix indicator (PMI)-based precoder prediction model trained with a training data set. The BS also includes a transceiver operatively coupled to the processor, the transceiver configured to receive at least one subband (SB)-level PMI-based precoder sequence and at least one subcarrier-level noisy SRS-based sequence. The processor is further configured to provide, to the trained joint SRS CE and PMI-based precoder prediction model, the at least one SB-level PMI-based precoder sequence and the at least one subcarrier-level noisy SRS-based sequence, and receive, from the trained joint SRS CE and PMI-based precoder prediction model, a predicted precoder generated by the trained joint SRS CE and PMI-based precoder prediction model based on the at least one SB-level PMI-based precoder sequence and the at least one subcarrier-level noisy SRS-based sequence.

In another embodiment, a method of operating a BS is provided. The method includes identifying a joint SRS CE and PMI-based precoder prediction model trained with a training data set, and receiving at least one SB-level PMI-based precoder sequence and at least one subcarrier-level noisy SRS-based sequence. The method also includes providing, to the trained joint SRS CE and PMI-based precoder prediction model, the at least one SB-level PMI-based precoder sequence and the at least one subcarrier-level noisy SRS-based sequence, and receiving, from the trained joint SRS CE and PMI-based precoder prediction model, a predicted precoder generated by the trained joint SRS CE and PMI-based precoder prediction model based on the at least one SB-level PMI-based precoder sequence and the at least one subcarrier-level noisy SRS-based sequence.

In yet another embodiment, a non-transitory computer readable medium embodying a computer program is provided. The computer program includes program code that, when executed by a processor of a device, causes the device to identify a joint SRS channel estimation CE and PMI-based precoder prediction model trained with a training data set, and receive at least one subband (SB)-level PMI-based precoder sequence and at least one subcarrier-level noisy SRS-based sequence. The program code also causes the device to provide, to the trained joint SRS CE and PMI-based precoder prediction model, the at least one SB-level PMI-based precoder sequence and the at least one subcarrier-level noisy SRS-based sequence, and receive, from the trained joint SRS CE and PMI-based precoder prediction model, a predicted precoder generated by the trained joint SRS CE and PMI-based precoder prediction model based on the at least one SB-level PMI-based precoder sequence and the at least one subcarrier-level noisy SRS-based sequence.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate” as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example 5G NR frame structure according to embodiments of the present disclosure;

FIGS. 5A-5B illustrates an example of PMI allocation and SRS allocation according to embodiments of the present disclosure;

FIG. 6 illustrates an example precoder prediction with high frequency granularity according to embodiments of the present disclosure;

FIG. 7 illustrates an example procedure for DL data transmission of a communication system that utilizes a precoder predictor according to embodiments of the present disclosure;

FIG. 8 illustrates an example neural network architecture for unified SRS channel estimation and precoder prediction according to embodiments of the present disclosure;

FIGS. 9A-9B illustrate example denoisers according to embodiments of the present disclosure;

FIG. 10 illustrates an example GRU-based precoder prediction network according to embodiments of the present disclosure;

FIG. 11 illustrates an example multidimensional interpolation procedure according to embodiments of the present disclosure;

FIG. 12 illustrates an example joint PMI/SRS interpolation and prediction network according to embodiments of the present disclosure; and

FIG. 13 illustrates an example method for joint CE and precoder prediction for TDD cellular communication according to embodiments of the present disclosure.

### DETAILED DESCRIPTION

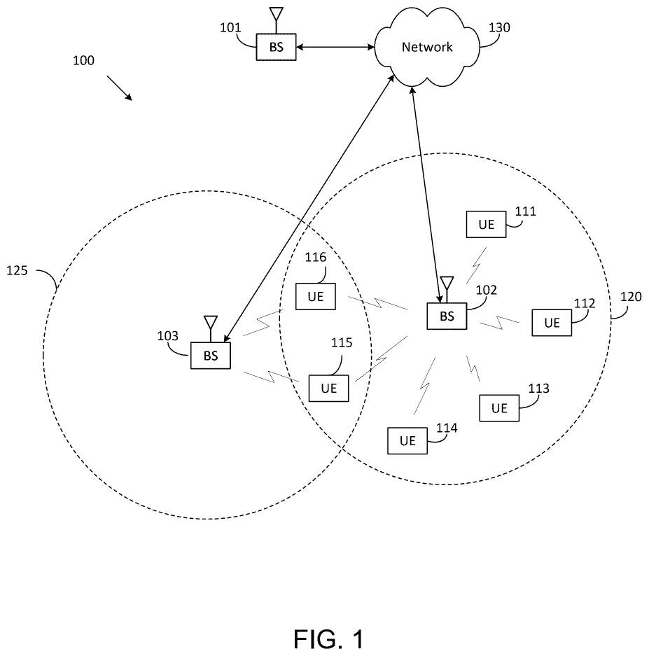

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for joint CE and precoder prediction for TDD cellular communication. In certain embodiments, one or more of the gNBs 101-103 includes circuitry, programing, or a combination thereof, to support joint CE and precoder prediction for TDD cellular communication in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

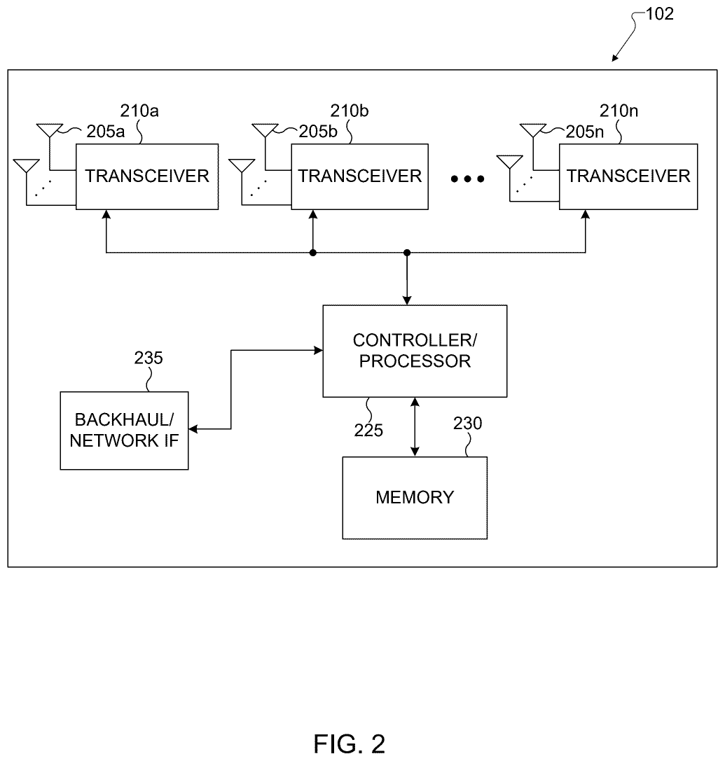

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to support joint CE and precoder prediction for TDD cellular communication as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

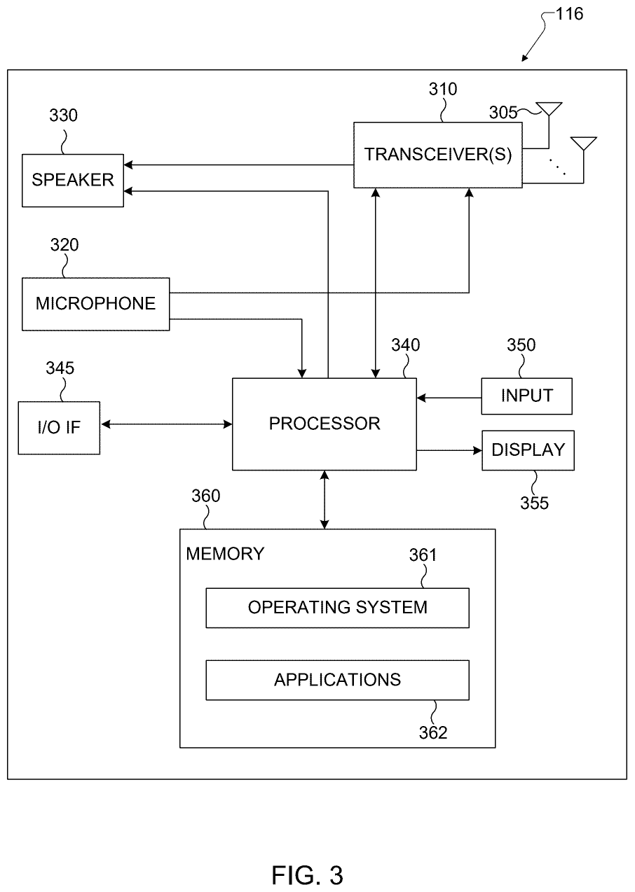

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for joint CE and precoder prediction for TDD cellular communication as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

Some channel state information (CSI) estimation techniques may utilize a sounding reference signal (SRS), which is a pilot signal transmitted in specific time-frequency resources on the uplink (UL). Modern cellular communication systems, such as 5G NR, can work in a time-division duplexing (TDD) mode that uses the same frequency band for both DL and UL communication, leading to channel reciprocity. In other words, a channel estimated via UL SRS can be used for DL communication, and vice versa. This is especially useful for multiple-input multiple output (MIMO) systems that exploit beamforming, also called precoding. In practice, least squares (LS), minimum mean square error (MMSE) or AI-based methods can be used to estimate the UL channel. The channel estimation (CE) accuracy is affected by the signal-to-noise ratio (SNR) which is usually low, particularly for a UE that is at the edge of the cells. Considering the limited power capability of UEs, edge UEs and UEs that do not have a line-of-sight (LOS) link with the base station (BS), suffer from low SNR.

An alternative to UL CE for DL MIMO communication in 5G NR is the precoding matrix indicator (PMI) feedback that is determined at the UE. The UE selects the most suitable beams from a codebook by utilizing the CSI reference signal (CSI-RS) transmitted by the BS. This information is transmitted back to the BS via the control channel. PMI feedback is especially useful when the UL SRS experiences low-SNR conditions. Both the CSI-RS transmission and PMI feedback create additional overhead. Thus, instead of PMI feedback per resource block (RB), a single PMI is transmitted per subband (SB) that comprises multiple RBs. Considering that the RBs contain consecutive subcarriers in 5G NR (which utilizes orthogonal frequency-division multiplexing [OFDM]), SB-level PMI feedback has low-resolution in the frequency-domain. Although interpolation methods can be adopted to overcome the low frequency resolution of PMI feedback in low delay spread (DS) conditions, this may not be the case for channels with high DS due to aliasing.

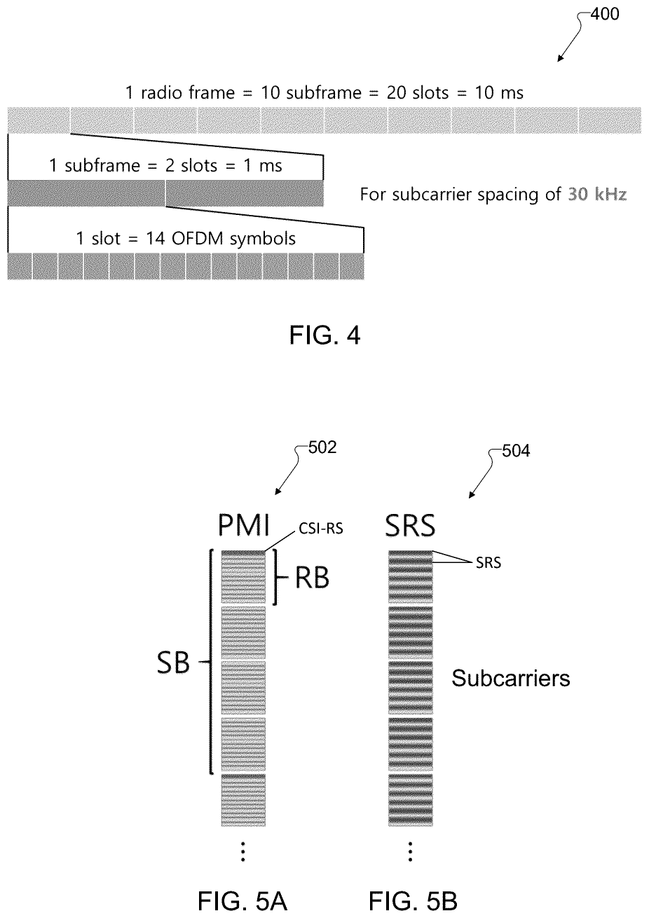

FIG. 4 illustrates an example 5G NR frame structure 400 according to embodiments of the present disclosure. The embodiment of a frame structure of FIG. 4 is for illustration only. Different embodiments of a frame structure could be used without departing from the scope of this disclosure.

In the example of FIG. 4, it can be seen that the frame of 5G NR frame structure 400 is 10 ms, and a subframe is 1 ms long. However, the number of slots in a subframe depends on the subcarrier spacing. 30 kHz is used as an example in FIG. 4, which corresponds to a slot duration of 0.5 ms. In addition, in the example of FIG. 4 a slot comprises 14 OFDM symbols which comprise K subcarriers. The SRS occupies an OFDM slot, while CSI-RS can occupy 1, 2 or 4 OFDM symbols. The SRS and CSI-RS are sent either periodically, semi-persistently, or aperiodically in the time-domain while keeping the overhead as low as possible. The period of the SRS ranges from 2 to 320 ms, whereas the CSI-RS period is defined in terms of a number of slots ranging from 4 to 640. Another way of reducing the overhead is to reduce the number of pilot tones in the frequency-domain. The UL SRS uses a comb pilot structure which corresponds to sending pilot tones every 2 or 4 subcarriers. On the other hand, the PMI feedback obtained via CSI-RS signals have sparse pilot tones over subcarriers. One approach is to send SB-level PMI feedback, where a SB comprises multiple RBs which cover 12 subcarriers.

Although FIG. 4 illustrates one example 5G NR frame structure 400, various changes may be made to FIG. 4. For example, various changes to the subcarrier spacing, the number of slots, etc. according to particular needs.

FIGS. 5A-5B illustrates an example of PMI allocation 502 and SRS allocation 504 according to embodiments of the present disclosure. The embodiment of PMI and SRS allocation of FIGS. 5A-5B is for illustration only. Different embodiments of PMI and SRS allocation could be used without departing from the scope of this disclosure.

FIGS. 5A-5B show PMI allocation 502 and SRS allocation 505 over subcarriers in an OFDM symbol. In the example of FIGS. 5A-5B, there are 4RBs per SB for PMI, and a comb-2 structure. The darker boxes show the subcarriers that carry CSI-RS and SRS, respectively.

Although FIGS. 5A-5B illustrates one example PMI allocation 502 and SRS allocation 504, various changes may be made to FIGS. 5A-5B. For example, various changes to number of RBs per SB, the comb structure, etc. could be made according to particular needs.

In addition to the mentioned shortcomings of CE and PMI feedback, UE mobility causes channel aging, resulting in more frequent CE and PMI feedback, which leads to increased overhead. To cope with channel aging, channel and precoder prediction can be employed. For example, artificial intelligence AI/machine learning ML techniques utilizing variations of neural network (NN)-based methods can be used in prediction tasks for channel and precoder prediction. In some embodiments, a convolutional neural network (CNN)-based architecture can be used for channel prediction, while a transformer-based network can be used for both channel and precoder prediction. It has been shown that recurrent neural network (RNN)-based solutions, such as long-short term memory (LSTM) and gated recurrent unit (GRU) architectures, can outperform other solutions including AI-based ones and Kalman filter which is a signal processing-based prediction method, or produce comparable performance without incurring a large computational overhead. In all of these examples, historical CSI data is assumed to be either noiseless or as having a high SNR.

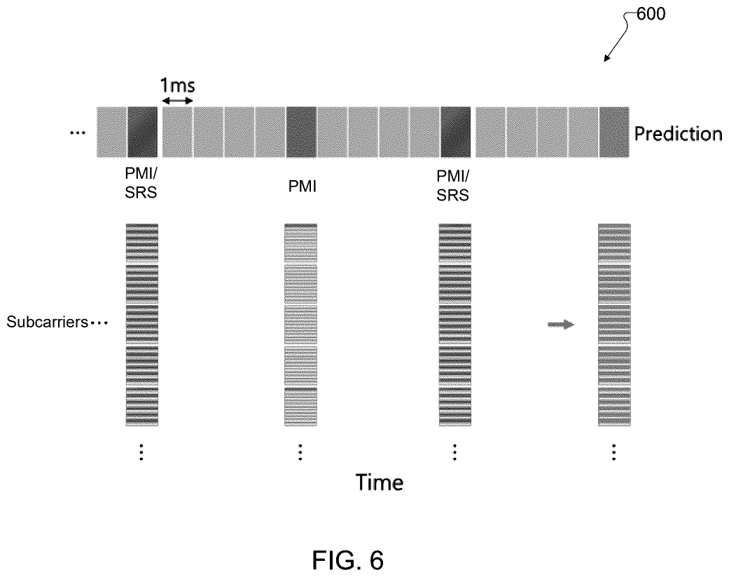

Some communication systems assume that the channel remains constant for a certain duration (i.e., coherence time) which is highly dependent on UE mobility. Once the channel is estimated or the PMI is received, the estimation or PMI is used until the next SRS or PMI arrives. If the UE mobility is high, more frequent updates are used. Another phenomenon is the DS which causes a rapid change of the channel response over subcarriers. Since PMI does not have enough granularity in the frequency-domain, linear interpolation or nearest neighbor methods usually do not improve the performance. While the SRS has higher resolution in the frequency-domain, the time periodicity of the SRS is usually lower. Furthermore, SRS experiences low-SNR conditions, especially for edge UEs. In those conditions, the BS uses PMI instead of SRS-based precoders. The drawbacks of both mechanisms lead to the problem of precoder prediction with high frequency granularity while utilizing the noisy SRS and historic SB-level PMI sequences. An illustration of the described problem is shown FIG. 6.

FIG. 6 illustrates an example precoder prediction with high frequency granularity 600 according to embodiments of the present disclosure. The embodiment of precoder prediction of FIG. 6 is for illustration only. Different embodiments of precoder prediction could be used without departing from the scope of this disclosure.

In the example of FIG. 6, the SRS and CSI-RS have 10 ms and 5 ms periodicities, respectively.

Although FIG. 6 illustrates one example precoder prediction with high frequency granularity 600, various changes may be made to FIG. 6. For example, various changes to periodicities, etc. could be made according to particular needs.

Various embodiments of the present disclosure provide precoder prediction by jointly utilizing SRS and PMI feedback to simultaneously deal with channel aging, high DS and noisy SRS. Since the eventual goal of CE and channel prediction is to construct the precoder in MIMO systems, precoder prediction without explicit channel prediction reduces the overall complexity and overhead of the system. Furthermore, SRS and PMI can be scheduled with a certain periodicity in 5G NR with the aim of keeping the period as long as possible to reduce the overhead. SRS has the advantage of higher resolution in the frequency-domain while PMI can be scheduled to have higher resolution in the time-domain. Taking advantage of both SRS and PMI sources can reduce the overall overhead.

In some embodiments, an AI-based precoder prediction method jointly utilizes the UL SRS and PMI feedback for precoder prediction. In some embodiments, the AI-based precoder prediction is performed for a 5G NR system adopting OFDM in TDD mode and containing a BS with Nₐₙₜ antennas and single-antenna UEs. In these embodiments, a mathematical model of the UL SRS signal can be described as

$${y}_{k} = {h}_{k} {x}_{k} + {n}_{k} , \qquad ( 1 )$$

where yₖ ∈ [symbol] ^{N}^{_{ant×1}} is the received signal at the BS antennas for the k-th pilot tone (subcarrier), hₖ ∈ [symbol] ^{N}^{_{ant×1}} denotes the channel vector across antennas, xₖ ∈ [symbol] is the transmitted pilot signal known to the receiver, and nₖ ∈ [symbol] ^{N}^{_{ant×1}} is the additive white Gaussian noise (AWGN). A straightforward CE method is the LS technique, which is the element-wise division, and the LS channel estimate can be expressed as

$${\hat{h}}_{k} = {h}_{k} + {w}_{k} , \qquad ( 2 )$$

where wₖ=nₖ/xₖ. The LS channel estimate has the same noise level as the received UL SRS. In practice, there are several CE options to decrease the noise level. There are signal processing-based solutions to denoise the LS channel estimate, such as MMSE estimator. Furthermore, the CE task is similar to denoising of images. Therefore, AI-based CE methods may be used that can essentially denoise the LS estimate of the channel as if the LS estimate were an image.

As noted above, for a TDD system the UL and DL channels are reciprocal. Thus, a DL precoder can be constructed by using the SRS-based LS channel estimate as

$${p}_{k}^{LS} = \frac{{\hat{h}}_{k}}{‖ {\hat{h}}_{k} ‖} .$$

On the other hand, the same channel can be estimated at the UE and PMI feedback can be constructed via CSI-RS signals. For example, Type II feedback may be used such that the precoder for the k-th subcarrier is constructed as

$${p}_{k}^{PMI} = {\sum }_{l = 1}^{L} {α}_{k , l} {w}_{k , l} , \qquad ( 3 )$$

$${w}_{k , l} ∈ 𝒲 ,$$

where L is the number of beams selected from the oversampled discrete Fourier transform (DFT) codebook W ∈ [symbol] ^{N}^{_{ant×N}}^{_{antO}} with the oversampling factor O. The complex gains and the selected beams are denoted by α_{k,l} ∈ [symbol] and w_{k,l} ∈ [symbol] ^{N}^{_{ant×1}}, respectively. While the gains and beams can be determined by maximizing the correlation, i.e.,

$$\vert {h}_{k}^{H} {p}_{k}^{PMI} \vert ,$$

various embodiments of the present disclosure may determine the gains and beams by utilizing the l2-distance between the channel-based precoder and the PMI-based precoder as

$$\{ {\hat{α}}_{k , l} \} , \{ {\hat{w}}_{k , l} \} = {min}_{\{ {a}_{k , l} \} , \{ {w}_{k , l} \} ∈ 𝒲} ‖ \frac{{h}_{k}}{‖ {h}_{k} ‖} - {\sum }_{l = 1}^{L} {α}_{k , l} {w}_{k , l} ‖ . \qquad ( 4 )$$

Note that the l2-norm of the precoder is normalized, i.e.

$$‖ {p}_{k}^{PMI} ‖ = 1.$$

The UE sends the beam gains and indices as feedback. To further reduce the feedback, common beams can be found for different subcarriers.

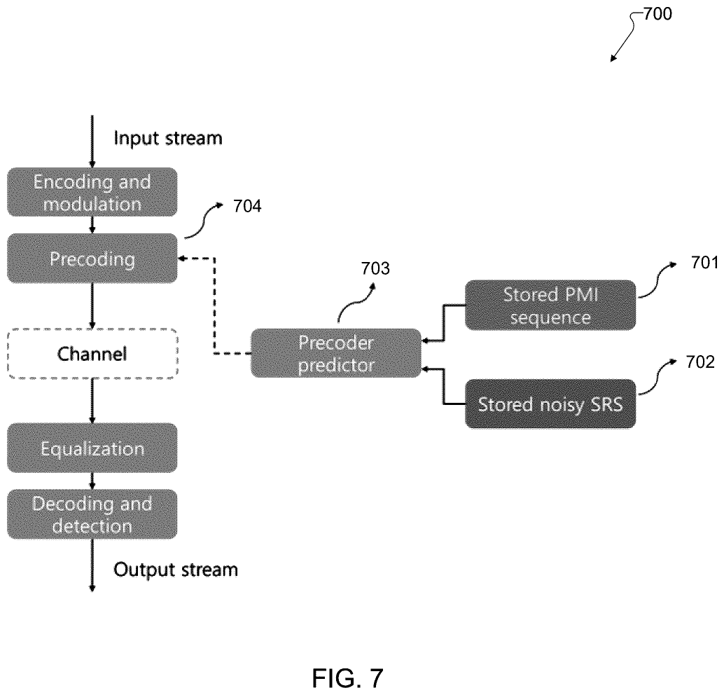

FIG. 7 illustrates an example procedure 700 for DL data transmission of a communication system that utilizes a precoder predictor according to embodiments of the present disclosure. An embodiment of the procedure illustrated in FIG. 700 is for illustration only. One or more of the components illustrated in FIG. 7 may be implemented in specialized circuitry configured to perform the noted functions or one or more of the components may be implemented by one or more processors executing instructions to perform the noted functions. Other embodiments or a procedure for DL data transmission of a communication system that utilizes a precoder predictor could be used without departing from the scope of this disclosure.

In the example of FIG. 7, procedure 700 begins in operations 701 and 702. In operation 701, previous PMI sequences are stored, while in operation 702, previous noisy SRS is stored.

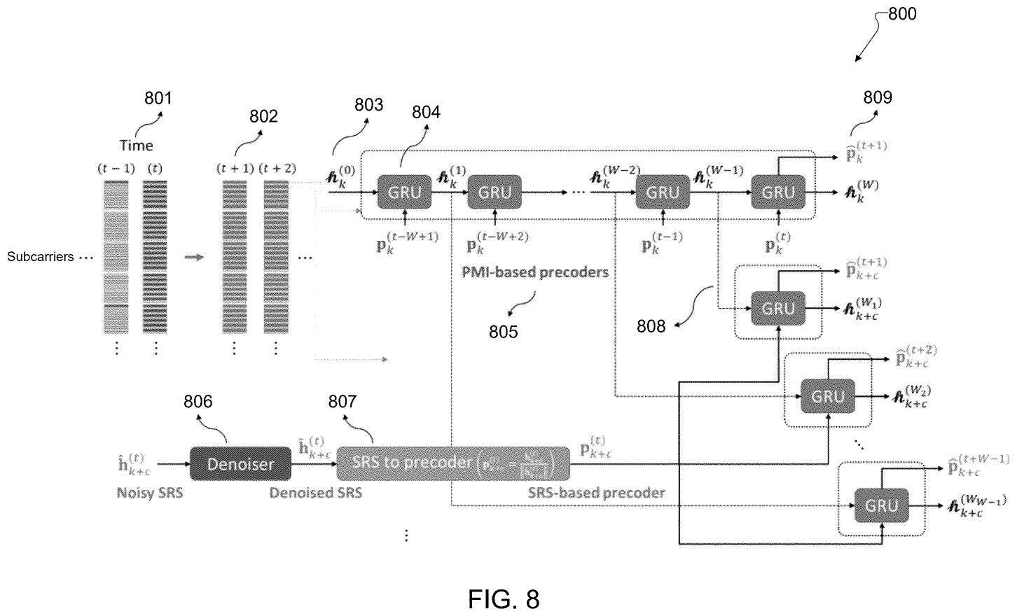

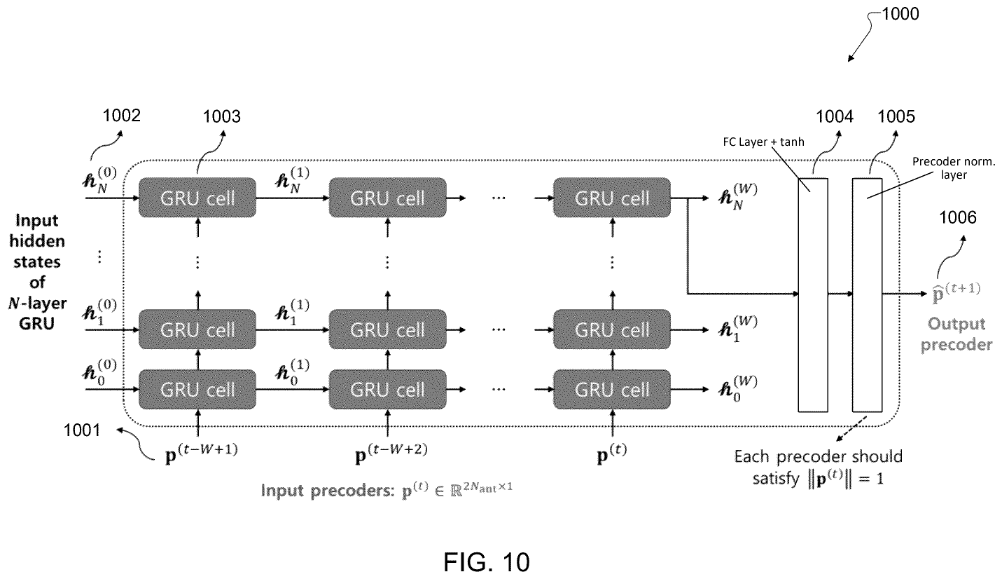

In operation 703, a precoder predictor module outputs a precoder. Unlike some systems where the precoder is computed via the latest noisy SRS or PMI, the precoder predictor module of operation 703 outputs a precoder based on an AI-based precoder predictor. For example, the AI-based precoder predictor may have an architecture identical or similar as described regarding neural network architecture 800 of FIG. 8 or GRU-based precoder prediction network 1000 of FIG. 10.

The DL data transmission procedure starts with the encoding and modulation of the input stream. In operation 704, the modulated signal is precoded. The input to the precoding module is the output of the precoder predictor given in operation 703. The precoded signal is transmitted to a UE which applies equalization, decoding and detection to the received signal.

Although FIG. 7 illustrates one example procedure 700 for DL data transmission of a communication system that utilizes a precoder predictor, various changes may be made to FIG. 7. For example, while shown as a series of operations, various operations in FIG. 7 could overlap, occur in parallel, occur in a different order, occur any number of times, be omitted, or replaced by other operations.

FIG. 8 illustrates an example neural network architecture 800 for unified SRS channel estimation and precoder prediction according to embodiments of the present disclosure. The embodiment of a neural network architecture of FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a neural network architecture for unified SRS channel estimation and precoder prediction could be used without departing from the scope of this disclosure.

In the example of FIG. 8, neural network architecture 800 is an RNN-based precoder prediction network that jointly denoises the SRS and predicts the future precoders with the help of PMI-based precoder sequences. Neural network architecture 800 considers the availability of SB-level PMI-based precoder and subcarrier-level SRS sequences for a window of length W.

In operation 801, historic sequences (e.g., sequences received in operations 701 and 702 of procedure 700) are stacked, where t is the time index.

In operation 802, predicted subcarrier-level precoders are obtained using the stacked sequences from operation 801 to generate an SB-level PMI-based precoder sequence 805.

After sequence 805 is obtained, the sequence 805 is provided to a GRU architecture that utilizes a hidden state that evolves at every prediction step. For illustration purposes, the initial hidden state and GRU cell are given in operations 803 and 804, respectively.

In operation 806, the subcarrier-level noisy SRS for at time step (t) is denoised, where c is the SRS periodicity in the frequency-domain due to the comb structure.

In operation 807, the denoised SRS is converted to a precoder.

In operation 808, the intermediate hidden states are obtained and fed to parallel GRU cells for each neighboring subcarrier. The hidden state before the last time step, i.e., (t−1), and the SRS at (t) are used to estimate the precoder at (t+1). Similarly, the hidden state at (t−2) and the SRS at (t) is used to estimate the precoder at (t+2).

Finally, in operation 809, the predicted precoders are obtained as the output of the GRU network.

Although FIG. 8 illustrates one example neural network architecture 800 for unified SRS channel estimation and precoder prediction, various changes may be made to FIG. 8. For example, while shown as a series of operations, various operations in FIG. 8 could overlap, occur in parallel, occur in a different order, occur any number of times, be omitted, or replaced by other operations.

In the example of FIG. 8, although the history of the subcarrier-level precoders is not available with the same time resolution of the PMI sequences, neural network architecture 800 uses the hidden states of the closest SB-level PMI-based precoder sequences to predict subcarrier-level precoders via the SRS. The subcarriers in an SB have similar channel responses. Furthermore, all the subcarriers are affected by the same UE mobility in time. Thus, the time evolution of the precoder sequences for different subcarriers should have similar characteristics. It can be shown that the autocorrelation of the channels at different subcarriers are the same under independent scattering and wide-sense stationary stochastic process assumptions. Because of this, neural network architecture 800 utilizes the hidden state before the last time step, i.e., (t−1), and the SRS at (t) to estimate the precoder at (t+1). Similarly, neural network architecture 800 uses the hidden state at (t−2) and the SRS at (t) to estimate the precoder at (t+2). This approach can be generalized to other time steps as well. The remainder of the present disclosure only considers the prediction of the precoders at (t+1). However, all the derivations can be generalized to the prediction of the precoders at next time steps.

In some embodiments, neural network architecture 800 may be trained utilizing a supervised learning approach for the training of the network. In some embodiments, the labels can be created by using the perfect (i.e., noiseless) channel at time step (t+1), which can be expressed as

$${p}_{k}^{( t + 1 )} = \frac{{h}_{k}^{( t + 1 )}}{‖ {\hat{h}}_{k}^{( t + 1 )} ‖} .$$

In some embodiments the mean square error (MSE) may be utilized as the loss function. In some embodiments, other functions such as cosine similarity can also be utilized as the loss function. Because the labels use the noiseless channel, neural network architecture 800 has the denoising capability.

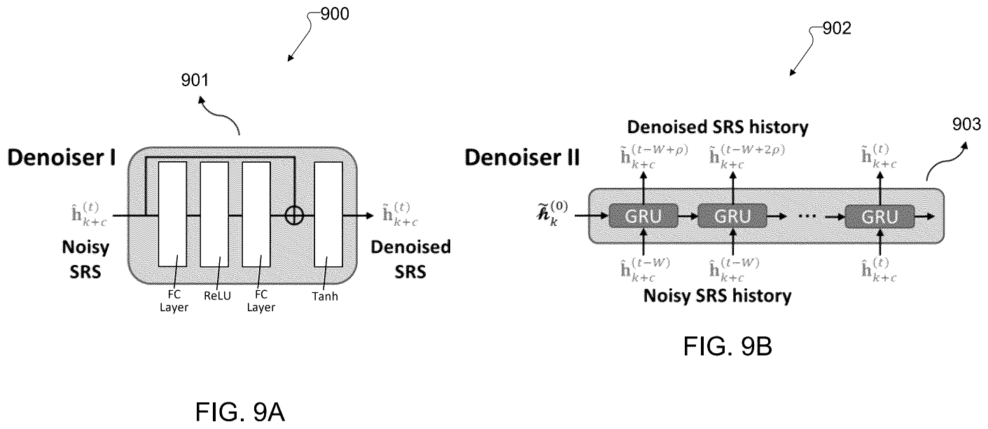

The denoising stage of the neural network architecture 800 can be implemented in various ways. For example, FIGS. 9A-9B show two distinct denoising architectures that could be used as denoising stages for neural network architecture 800. However, neural network architecture is not limited to the denoising architectures shown in FIGS. 9A-9B, and neural network architecture 800 may utilize any denoising architecture as a denoising stage.

FIGS. 9A-9B illustrate example denoisers 900 and 902 according to embodiments of the present disclosure. An embodiment of the denoisers illustrated in FIGS. 9A-9B is for illustration only. One or more of the components illustrated in FIGS. 9A-9B may be implemented in specialized circuitry configured to perform the noted functions or one or more of the components may be implemented by one or more processors executing instructions to perform the noted functions. Other embodiments of denoisers could be used without departing from the scope of this disclosure.

In operation 901, the first denoiser 900 takes the noisy SRS at the last time step as the input and applies a residual neural network (NN) architecture for image denoising.

In operation 903, the second denoiser 902 takes the noisy SRS at previous time steps as the input. The architecture of the second denoiser 902 utilizes another GRU network to denoise the given noisy SRS sequence at the output. Note that the periodicity of the SRS is larger than the periodicity of the PMI. Thus, the time difference between consecutive SRS samples is denoted by ρ. For instance, p=2 when the SRS and CSI-RS periods are 10 and 5 ms, respectively.

Although FIGS. 9A-9B illustrate one example denoisers 900 and 902, various changes may be made to FIGS. 9A-9B. For example, while shown as a series of operations, various operations in FIGS. 9A-9B could overlap, occur in parallel, occur in a different order, occur any number of times, be omitted, or replaced by other operations.

While neural network architecture 800 uses the denoised SRS as described regarding FIG. 8, the denoised SRS can be used for other purposes. Some example uses for the denoised SRS include CSI quality estimation and UL scheduling.

AI-based precoder prediction (for example, at operation 703 of procedure 700) is not restricted to a specific architecture such as network architecture 800 as shown in FIG. 8. For example, in some embodiments (referred to herein as “Option I”), the GRU-based predictor may be trained with both SB-level PMI-based precoder sequences and the noisy SRS at the last step without the denoiser while the labels are obtained via perfect (i.e., noiseless) channels. In some embodiments (referred to herein as “Option II”), the GRU-based precoder is trained with both SB-level PMI-based precoder sequences and the noisy SRS with the denoiser while the labels are obtained via perfect channels.

In some embodiments, a plurality of metrics may be used to investigate the performance of the architecture provided herein. For example, the plurality of metrics may include one or more of DL spectral efficiency, throughput, etc. In some embodiments, the DL spectral efficiency that can be computed as

$${SE}_{k}^{( t + 1 )} = {log}_{2} ( 1 + {SNR}_{DL} {\vert {[ {h}_{k}^{( t + 1 )} ]}^{H} {\hat{p}}_{k}^{( t + 1 )} \vert}^{2} ) , \qquad ( 5 )$$

where SNR_{DL} is the DL SNR. This metric shows the achievable data rate when a specific precoder is utilized. DL spectral efficiency can be calculated with system level simulations. Throughput that can be calculated via link level simulations. That is, data bits are created, encoded, transmitted over the channel, and decoded. The bit error rate (BER) and block error rate (BLER) can be calculated to investigate the amount of the data recovered correctly. Finally, the throughput can be calculated by computing the correctly recovered data per unit time.

As an alternative to neural network architecture 800, which uses perfect channels as labels, AI-based precoder prediction (for example, at operation 703 of procedure 700) may use a precoder prediction network that only uses SB-level PMI-based precoder sequences for the training of the network while the labels are also PMI-based precoders. An example GRU-based precoder prediction network for SB-level precoders is shown in FIG. 10.

FIG. 10 illustrates an example GRU-based precoder prediction network 1000 according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a GRU-based precoder prediction network could be used without departing from the scope of this disclosure.

In the example of FIG. 10, the GRU-based precoder prediction network 1000 begins at operation 1001. In operation 1001, precoders p^{(t)} ∈ [symbol] ^{2N}^{_{ant×1}} (e.g., from operation 701 of process 700) are given as the input to the network. Note that the subcarrier subscript is omitted in FIG. 10. Since NNs with complex values are not practical or common, the real and imaginary parts of the precoders are separated and concatenated.

In operation 1002, hidden states of the GRU layers are initialized with all zeros. As shown in FIG. 10, network 1000 is a flexible network with N-layers.

In operation 1003, a GRU cell of a layer takes the previous hidden state and the output from other layers as inputs, and computes the next hidden state as the output. The last hidden state of the last GRU layer is taken to compute the precoder.

In operation 1004, the precoder is computed with a fully-connected layer and tanh activation function.

Since each precoder should have unit norm, a normalization layer is included in operation 1005.

In operation 1006, the predicted precoder at the output of the normalization layer is obtained. Finally, the output can be converted back to a complex vector. The detailed structure of the GRU outlined in FIG. 10 is also valid for the embodiment of neural network architecture 800 shown in FIG. 8.

Although FIG. 10 illustrates one example GRU-based precoder prediction network 1000, various changes may be made to FIG. 10. For example, while shown as a series of operations, various operations in FIG. 10 could overlap, occur in parallel, occur in a different order, occur any number of times, be omitted, or replaced by other operations.

The embodiment of network 1000 presumes that a history of PMI-based precoders are available. Since PMI-based precoders are readily utilized in commercial networks, it is practical to collect these sequences. The collected sequences can be used for the supervised training of the GRU-based precoder prediction network 1000. Although network 1000 serves as a basis for precoder prediction, it should be noted that only SB-level PMI are available, which means only SB-level precoders can be predicted. Some approaches may utilize linear interpolation or nearest neighbor methods to find subcarrier-level precoders from the SB-level precoders. This is not desirable especially if the DS is large.

In some embodiments SRS can be integrated to the prediction system to predict subcarrier-level precoders since SRS has higher frequency resolution. Similar to the embodiment of neural network architecture 800 shown in FIG. 8, the hidden state at the last time step can be used for subcarrier-level precoder prediction via SRS in the embodiment of GRU-based precoder prediction network 1000 shown in FIG. 10. In these embodiments, different from neural network architecture 800, the network 1000 is trained with only SB-level PMI-based precoder sequences and labels, while the SRS is only used during inference. The SRS input at the last time step can be noisy or denoised.

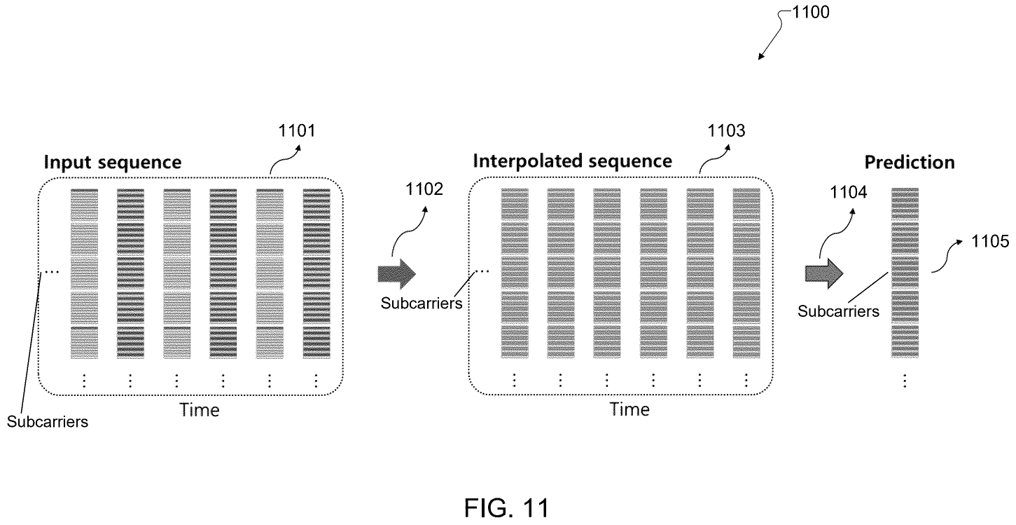

In the examples of neural network architecture 800 and GRU-based precoder prediction network 1000, SRS is only used for the predictions at the last time step. While it is possible to have noisy SRS samples at previous time steps, the difference between the periodicities of SRS and PMI make a unified prediction architecture utilizing these previous SRS samples unfeasible. To overcome this issue caused by the difference in periodicities, various embodiments of the present disclosure may utilize a multidimensional interpolation stage as shown in FIG. 11 to utilize the previous SRS samples as part of a precoder prediction.

FIG. 11 illustrates an example multidimensional interpolation procedure 1100 according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a multidimensional interpolation procedure could be used without departing from the scope of this disclosure.

In operation 1101, SB-level precoder sequences and SRS-based precoders are received as input (e.g., sequences received in operations 701 and 702 of procedure 700). As shown in operation 1101, SB-level precoder sequences and SRS-based precoders create a non-uniform grid.

In operation 1102, the precoders are interpolated to fill the empty subcarriers, generating an interpolated sequence 1103.

In operation 1104, the precoders for the next time step are predicted from the interpolated sequence 1103.

In operation 1105 the predicted precoders are provided as output of the precoder predictor module (e.g., for operation 703 of procedure 700).

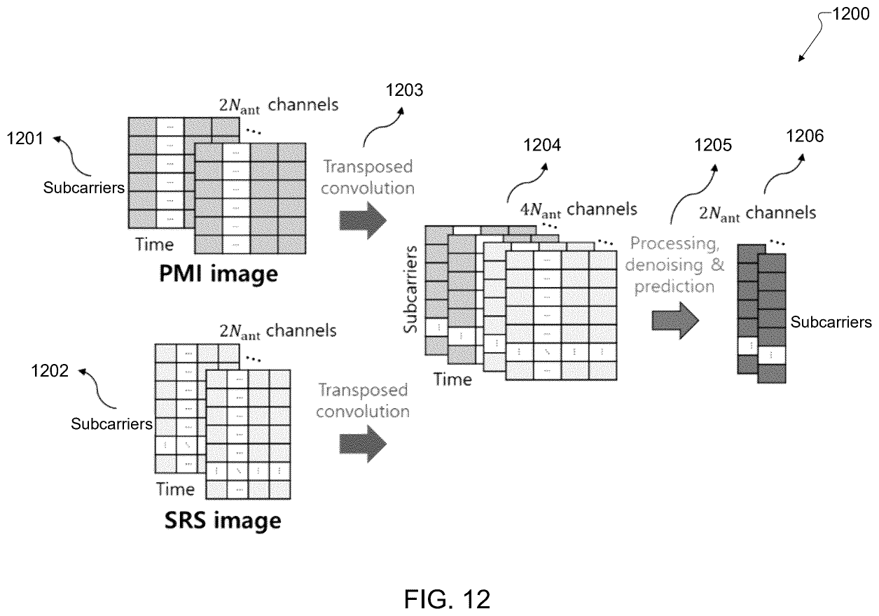

In the various embodiments described herein, the denoising of the noisy SRS can be provided at different stages: (i) prior to the interpolation operation 1102, of (ii) after the interpolation operation 1102. Furthermore, in the various embodiments described herein the interpolation stage can be provided either separately or jointly with the prediction network (e.g., network 1000). In some embodiments, which may use the separate approach, interpolation techniques such as multidimensional linear interpolation can be utilized. Subsequently, a prediction network such as the neural network architecture 800 shown in FIG. 8 or the GRU-based precoder prediction network 1000 shown in FIG. 10 can be utilized to predict the precoders at the next time step. In some embodiments, a super-resolution network may be used before the prediction operation as shown in FIG. 12.

Although FIG. 11 illustrates one example multidimensional interpolation procedure 1100, various changes may be made to FIG. 11. For example, while shown as a series of operations, various operations in FIG. 11 could overlap, occur in parallel, occur in a different order, occur any number of times, be omitted, or replaced by other operations.

FIG. 12 illustrates an example joint PMI/SRS interpolation and prediction network 1200 according to embodiments of the present disclosure. An embodiment of the network illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a joint PMI/SRS interpolation and prediction network could be used without departing from the scope of this disclosure.

In the example of FIG. 12, the network 1200 begins at operations 1201 and 1202. At operations 1201 and 1202, the available PMI and SRS sources (e.g., sequences received in operations 701 and 702 of procedure 700) can be considered as images in a time-frequency plane with multiple channels corresponding to the real and imaginary parts of the entries for each antenna.

Since the PMI and SRS images of operations 1201 and 1202 have different resolutions in the time and frequency dimensions, network 1200 includes a trainable upsampling layer, which may be referred to a transposed convolution (or deconvolution) operation, shown as operation 1203.

In operation 1204, the upsampled images of PMI and SRS are concatenated as different channels.

The next stage, shown in operation 1205, is used for several steps, such as denoising the SRS, information fusion from PMI and SRS sources, and prediction of the precoders. In some embodiments, the prediction can be made with the GRU-based predictor (e.g., network 1000), or other approaches such as CNN layers.

In operation 1206, the predicted precoders provided based on the output from operation 1205.

The joint approach provides end-to-end learning for the interpolator and predictor. This option has the potential to improve the performance significantly due to the joint training and extra processing. However, the complexity of the model increases both in terms of the model parameters and the computation.

Although FIG. 12 illustrates one example method for joint PMI/SRS interpolation and prediction network 1200, various changes may be made to FIG. 12. For example, while shown as a series of operations, various operations in FIG. 12 could overlap, occur in parallel, occur in a different order, occur any number of times, be omitted, or replaced by other operations.

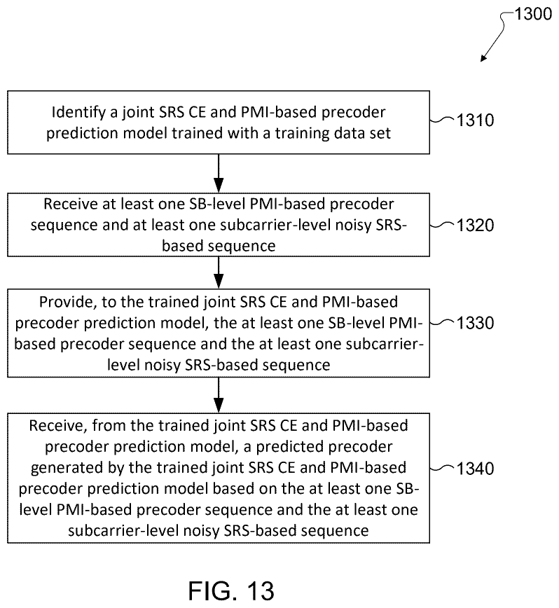

FIG. 13 illustrates an example method 1300 for joint CE and precoder prediction for TDD cellular communication according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a method for joint CE and precoder prediction for TDD cellular communication could be used without departing from the scope of this disclosure.

In the example of FIG. 13, method 1300 begins at step 1310. At step 1310, at least one element of a wireless network (hereinafter “network element”) such as BS 102 of FIG. 1 identifies a joint SRS CE and PMI-based precoder prediction model (for example, neural network architecture 800 or network 1000) trained with a training data set.

In some embodiments, prior to step 1310, the at least one network element may obtain at least one subcarrier-level training sequence comprising a nearest SB-level PMI-based precoder, and train the joint SRS CE and PMI-based precoder prediction model based on the at least one subcarrier-level training sequence.

In some embodiments, the joint SRS CE and PMI-based precoder prediction model may comprise an SRS denoising stage (such as denoiser 900 or 902). In some embodiments, prior to step 1410, the at least one network element may obtain at least one subcarrier-level noisy SRS training sequence, and train the joint SRS CE and PMI-based precoder prediction model based on the at least one subcarrier-level noisy SRS training sequence.

At step 1320, the at least one network element receives at least one SB-level PMI-based precoder sequence and at least one subcarrier-level noisy SRS-based sequence (for example, stored sequences similar as described regarding operations 701 and 702 of procedure 700).

At step 1330, the at least one network element provides, to the trained joint SRS CE and PMI-based precoder prediction model, the at least one SB-level PMI-based precoder sequence and the at least one subcarrier-level noisy SRS-based sequence (for example, similar as described regarding operations 701-703 of procedure 700).

At step 1340, the at least one network element receives, from the trained joint SRS CE and PMI-based precoder prediction model, a predicted precoder generated by the trained joint SRS CE and PMI-based precoder prediction model based on the at least one SB-level PMI-based precoder sequence and the at least one subcarrier-level noisy SRS-based sequence (for example, similar as described regarding operation 703 of procedure 700).

While steps 1310-1340 are described above as being performed by the same at least one network element, this is merely for ease of explanation. For example, in some embodiments, each of steps 1310-1340 may be performed by a different network element, or a different plurality of network elements.

In some embodiments, the joint SRS CE and PMI-based precoder prediction model may comprise a RNN configured to apply the at least one SB-level PMI-based precoder sequence to each of a plurality of prediction steps (for example, similar as described regarding neural network architecture 800). The plurality of prediction steps may use hidden states that evolve at each of the plurality of prediction steps. The predicted PMI may be generated by the RNN.

In some embodiments, the joint SRS CE and PMI-based precoder prediction model may comprise a prior interpolation stage configured to interpolate SB-level PMI-based precoder sequences and subcarrier-level noisy SRS-based sequences (for example, similar as described regarding interpolation operation 1102). The predicted PMI may be generated based on interpolated SB-level PMI-based precoder sequences and subcarrier-level noisy SRS-based sequences interpolated by the prior interpolation stage. In some embodiments, the joint SRS CE and PMI-based precoder prediction model may comprise a prediction network. The joint SRS CE and PMI-based precoder prediction model may be configured to use the interpolated SB-level PMI-based precoder sequences and subcarrier-level noisy SRS-based sequences interpolated by the prior interpolation stage as input for the prediction network (for example, similar as described regarding multidimensional interpolation procedure 1100). The predicted PMI may be generated by the prediction network.

In some embodiments, where the joint SRS CE and PMI-based precoder prediction model comprises an SRS denoising stage, the SRS denoising stage may comprise a residual neural NN (such as in denoiser 900). The SRS denoising stage may be configured to apply a most recent time step noisy SRS-based sequence of the at least one subcarrier-level noisy SRS-based sequence to the residual NN. The joint SRS CE and PMI-based precoder prediction model may be configured to generate the PMI prediction based on an output of the residual NN.

In some embodiments, where the joint SRS CE and PMI-based precoder prediction model comprises an SRS denoising stage, the SRS denoising stage may comprise a GRU network (such as in denoiser 902). The SRS denoising stage may be configured to apply the at least one subcarrier-level noisy SRS-based sequence to the GRU network. The joint SRS CE and PMI-based precoder prediction model may be configured to generate the PMI prediction based on an output of the GRU network.

Although FIG. 13 illustrates one example method 1300 for joint CE and precoder prediction for TDD cellular communication, various changes may be made to FIG. 13. For example, while shown as a series of steps, various steps in FIG. 13 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
a processor configured to identify a joint sounding reference signal (SRS) channel estimation (CE) and precoding matrix indicator (PMI)-based precoder prediction model trained with a training data set; and
a transceiver operatively coupled to the processor, the transceiver configured to receive at least one subband (SB)-level PMI-based precoder sequence and at least one subcarrier-level noisy SRS-based sequence,
wherein the processor is further configured to:
provide, to the trained joint SRS CE and PMI-based precoder prediction model, the at least one SB-level PMI-based precoder sequence and the at least one subcarrier-level noisy SRS-based sequence; and
receive, from the trained joint SRS CE and PMI-based precoder prediction model, a predicted precoder generated by the trained joint SRS CE and PMI-based precoder prediction model based on the at least one SB-level PMI-based precoder sequence and the at least one subcarrier-level noisy SRS-based sequence.

2. The BS of claim 1, wherein:
the joint SRS CE and PMI-based precoder prediction model comprises a recurrent neural network (RNN) configured to apply the at least one SB-level PMI-based precoder sequence to each of a plurality of prediction steps;
the plurality of prediction steps use hidden states that evolve at each of the plurality of prediction steps; and
the predicted PMI is generated by the RNN.

3. The BS of claim 1, wherein:
the joint SRS CE and PMI-based precoder prediction model comprises a prior interpolation stage configured to interpolate SB-level PMI-based precoder sequences and subcarrier-level noisy SRS-based sequences; and
the predicted precoder is generated based on interpolated SB-level PMI-based precoder sequences and subcarrier-level noisy SRS-based sequences interpolated by the prior interpolation stage.

4. The BS of claim 3, wherein:
the joint SRS CE and PMI-based precoder prediction model comprises a prediction network;
the joint SRS CE and PMI-based precoder prediction model is configured to use the interpolated SB-level PMI-based precoder sequences and subcarrier-level noisy SRS-based sequences interpolated by the prior interpolation stage as input for the prediction network; and
the predicted precoder is generated by the prediction network.

5. The BS of claim 1, wherein:
the processor is further configured to obtain at least one subcarrier-level training sequence comprising a nearest SB-level PMI-based precoder; and
the joint SRS CE and PMI-based precoder prediction model is trained based on the at least one subcarrier-level training sequence.

6. The BS of claim 5, wherein:
the joint SRS CE and PMI-based precoder prediction model comprises an SRS denoising stage;
the processor is further configured to obtain at least one subcarrier-level noisy SRS training sequence; and
the joint SRS CE and PMI-based precoder prediction model is trained based on the at least one subcarrier-level noisy SRS training sequence.

7. The BS of claim 6, wherein:
the SRS denoising stage comprises a residual neural network (NN);
the SRS denoising stage is configured to apply a most recent time step noisy SRS-based sequence of the at least one subcarrier-level noisy SRS-based sequence to the residual NN; and
the joint SRS CE and PMI-based precoder prediction model is configured to generate the precoder prediction based on an output of the residual NN.

8. The BS of claim 6, wherein:
the SRS denoising stage comprises a gated recurrent unit (GRU) network;
the SRS denoising stage is configured to apply the at least one subcarrier-level noisy SRS-based sequence to the GRU network; and
the joint SRS CE and PMI-based precoder prediction model is configured to generate the precoder prediction based on an output of the GRU network.

9. A method of operating a base station (BS), the method comprising:
identifying a joint sounding reference signal (SRS) channel estimation (CE) and precoding matrix indicator (PMI)-based precoder prediction model trained with a training data set;
receiving at least one subband (SB)-level PMI-based precoder sequence and at least one subcarrier-level noisy SRS-based sequence;
providing, to the trained joint SRS CE and PMI-based precoder prediction model, the at least one SB-level PMI-based precoder sequence and the at least one subcarrier-level noisy SRS-based sequence; and
receiving, from the trained joint SRS CE and PMI-based precoder prediction model, a predicted precoder generated by the trained joint SRS CE and PMI-based precoder prediction model based on the at least one SB-level PMI-based precoder sequence and the at least one subcarrier-level noisy SRS-based sequence.

10. The method of claim 9, wherein:
the joint SRS CE and PMI-based precoder prediction model comprises a recurrent neural network (RNN) configured to apply the at least one SB-level PMI-based precoder sequence to each of a plurality of prediction steps;
the plurality of prediction steps use hidden states that evolve at each of the plurality of prediction steps; and
the predicted precoder is generated by the RNN.

11. The method of claim 9, wherein:
the joint SRS CE and PMI-based precoder prediction model comprises a prior interpolation stage configured to interpolate SB-level PMI-based precoder sequences and subcarrier-level noisy SRS-based sequences; and
the predicted precoder is generated based on interpolated SB-level PMI-based precoder sequences and subcarrier-level noisy SRS-based sequences interpolated by the prior interpolation stage.

12. The method of claim 11, wherein:
the joint SRS CE and PMI-based precoder prediction model comprises a prediction network;
the joint SRS CE and PMI-based precoder prediction model is configured to use the interpolated SB-level PMI-based precoder sequences and subcarrier-level noisy SRS-based sequences interpolated by the prior interpolation stage as input for the prediction network; and
the predicted precoder is generated by the prediction network.

13. The method of claim 9, further comprising:
obtaining at least one subcarrier-level training sequence comprising a nearest SB-level PMI-based precoder,
wherein the joint SRS CE and PMI-based precoder prediction model is trained based on the at least one subcarrier-level training sequence.

14. The method of claim 13, wherein:
the joint SRS CE and PMI-based precoder prediction model comprises an SRS denoising stage;
the method further comprises obtaining at least one subcarrier-level noisy SRS training sequence; and
the joint SRS CE and PMI-based precoder prediction model is trained based on the at least one subcarrier-level noisy SRS training sequence.

15. The method of claim 14, wherein:
the SRS denoising stage comprises a residual neural network (NN);
the SRS denoising stage is configured to apply a most recent time step noisy SRS-based sequence of the at least one subcarrier-level noisy SRS-based sequence to the residual NN; and
the joint SRS CE and PMI-based precoder prediction model is configured to generate the precoder prediction based on an output of the residual NN.

16. The method of claim 14, wherein:
the SRS denoising stage comprises a gated recurrent unit (GRU) network;
the SRS denoising stage is configured to apply the at least one subcarrier-level noisy SRS-based sequence to the GRU network; and
the joint SRS CE and PMI-based precoder prediction model is configured to generate the precoder prediction based on an output of the GRU network.

17. A non-transitory computer readable medium embodying a computer program comprising program code that, when executed by a processor of a device, causes the device to:
identify a joint sounding reference signal (SRS) channel estimation (CE) and precoding matrix indicator (PMI)-based precoder prediction model trained with a training data set; and
receive at least one subband (SB)-level PMI-based precoder sequence and at least one subcarrier-level noisy SRS-based sequence;
provide, to the trained joint SRS CE and PMI-based precoder prediction model, the at least one SB-level PMI-based precoder sequence and the at least one subcarrier-level noisy SRS-based sequence; and
receive, from the trained joint SRS CE and PMI-based precoder prediction model, a predicted precoder generated by the trained joint SRS CE and PMI-based precoder prediction model based on the at least one SB-level PMI-based precoder sequence and the at least one subcarrier-level noisy SRS-based sequence.

18. The non-transitory computer readable medium of claim 17, wherein:
the joint SRS CE and PMI-based precoder prediction model comprises a recurrent neural network (RNN) configured to apply the at least one SB-level PMI-based precoder sequence to each of a plurality of prediction steps;
the plurality of prediction steps use hidden states that evolve at each of the plurality of prediction steps; and
the predicted precoder is generated by the RNN.

19. The non-transitory computer readable medium of claim 17, wherein:
the joint SRS CE and PMI-based precoder prediction model comprises a prior interpolation stage configured to interpolate SB-level PMI-based precoder sequences and subcarrier-level noisy SRS-based sequences;
the predicted precoder is generated based on interpolated SB-level PMI-based precoder sequences and subcarrier-level noisy SRS-based sequences interpolated by the prior interpolation stage;
the joint SRS CE and PMI-based precoder prediction model comprises a prediction network;
the joint SRS CE and PMI-based precoder prediction model is configured to use the interpolated SB-level PMI-based precoder sequences and subcarrier-level noisy SRS-based sequences interpolated by the prior interpolation stage as input for the prediction network; and
the predicted precoder is generated by the prediction network.

20. The non-transitory computer readable medium of claim 17, wherein:
the computer program comprising program code, when executed by the processor of the device, causes the device to obtain at least one subcarrier-level training sequence comprising a nearest SB-level PMI-based precoder; and
the joint SRS CE and PMI-based precoder prediction model is trained based on the at least one subcarrier-level training sequence.
